(19) United States
(12) Patent Application Publication
(10) Pub. No.: US 2007/0121434 A1
(43) Pub. Date: May 31, 2007

(54) Actuator for a scanning device for scanning optical discs

(75) Inventors: Tsuneo Suzuki, Moenchweiler (DE); Michael Bammert, Hardt (DE); Rolf Dupper, Villingen-Schwenningen (DE)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: Thomson Licensing Inc.

(21) Appl. No.: 11/600,578

(22) Filed: Nov. 16, 2006

(30) Foreign Application Priority Data
Nov. 25, 2005 (EP) 05111327.2

(51) Int. Cl. G11B 7/00

(52) U.S. Cl. 369/44.14

(57) ABSTRACT

The invention relates to an actuator for a scanning device for scanning optical discs which has a focus lens fixed in a lens holder and a damper base permanently connected to a support. The actuator is equipped with a coil and magnet arrangement, arranged on a support, for fine positioning of the focus lens, wherein a frame is connected to the damper base with elastically flexible suspension means arranged on both sides of this arrangement and of a longitudinal axis of the actuator. It achieves the object of constructing such an actuator in such a manner that it is also suitable for small optical discs. For this purpose, the lens holder is arranged at a distance from the longitudinal axis and at the same time on a side of the actuator facing away from it and facing a receptacle for the optical discs, wherein the direction of movement of the scanning device with the actuator is located transversely to the longitudinal axis and radially with respect to the disc.

### FIELD OF THE INVENTION

The invention relates to an actuator for a scanning device for scanning optical discs, particularly for a device for recording and/or reproducing information.

### BACKGROUND OF THE INVENTION

An actuator integrated in a scanning device is used for the emission of a laser beam onto an optical disc constructed as information medium and for receiving the beam reflected from the disc. For this purpose, the actuator has a focus lens and is attached adjustably with a support to an optical housing, also known as pickup, which can be moved on guide rods in order to be able to align the focus lens in accordance with the optical path of the housing. This housing, and thus the entire scanning device, can be moved at high speed and positioning accuracy by electric motor and ensures short access times to different locations on the information medium. In this arrangement, the scanning device focuses a beam of radiation for forming a radiation point on a track to be scanned on the information medium. This radiation point follows the track of the rotating information medium during recording or production. This is done with the aid of a track control system which provides for coarse control of the carriage-like housing and of the actuator in a radial direction of the disc and a fine control of the actuator. The actuator is preferably attached with a support plate at the optical housing and has a lens holder for the focus lens, a damper base, rigidly connected to the support plate, and focus and track guidance coils, the lens holder being connected elastically resiliently to the damper base with the aid of elastically flexible suspension means, particularly also wires.

As disclosed in EP 1 394 783 A2, the actuator is usually constructed symmetrically in the direction of movement of the optical housing. In this arrangement, the lens holder is arranged on the side facing away from the damper base of a coil arrangement comprising the focus and track guidance coils and tilt coils and positioned between magnets, the center of which preferably lies at the center of gravity of the actuator, wherein elastically flexible suspension wires for the lens holder are arranged on both sides of the longitudinal axis determined by the lens holder and the damper base, which longitudinal axis is at the same time the axis of symmetry. The lens holder is thus located at the front end of the actuator and is moved orthogonal to the longitudinal axis in a radial direction with respect to the optical disc towards the latter and away from the latter.

In EP 0 618 570 B1, an arrangement is described in which an actuator basically constructed in the same manner is moved with the optical housing transversely with respect to its longitudinal axis and at the same time also radially with respect to the optical disc.

### SUMMARY OF THE INVENTION

In these lens holder arrangements in the center of the actuator, it is considered to be disadvantageous that the actuator and particularly the lens cannot be moved close enough to the center of the respective optical disc which is absolutely necessary for scanning small discs, for example coin-sized discs having a diameter of the order of magnitude of 30 mm.

It is the object of the invention to construct an actuator in such a manner that it is also suitable for small optical discs.

According to the invention, this object is achieved in that the lens holder is arranged at a distance from the longitudinal axis and at the same time on the side of the actuator facing a receptacle for the optical discs. Advantageous embodiments are listed in the subclaims.

The invention consists in the fact that in an actuator for a device for scanning optical discs with a lens holder, connected on both sides of its longitudinal axis with elastically flexible suspension means to a damper base, the lens holder is arranged at a distance from the longitudinal axis, on that side of the suspension means which face the center of the optical disc. This asymmetric arrangement of the lens holder outside the actuator suspension makes it possible to move a focus lens held in the lens holder very close to the center even of a small optical disc so that even the inner area of the information track of this disc can be scanned with the focussed laser beam.

In order that the center of gravity of the actuator still coincides with the center of the coil and magnet arrangement and at the same time on its longitudinal axis in order to facilitate a fine adjustment of the focus lens, the lens holder with the focus lens is arranged at a lateral distance from the center given on the longitudinal axis and is connected to a balance weight on the other side of the longitudinal axis and of the center.

In this arrangement, it is suitable to arrange the lens holder and the balance weight on a frame enclosing the coil and magnet arrangement and to implement them as an integral component with the frame. This reduces the variety of components and lowers assembly costs. The elastic suspension means, particularly wires, for the lens holder can be connected to this frame.

The actuator is preferably arranged on the optical housing of the scanning device in such a manner that the scanning device is moved radially with respect to the optical disc and transversely with respect to the longitudinal axis of the actuator.

### BRIEF DESCRIPTION OF THE DRAWINGS

It the text which follows the invention will be explained with reference to an illustrative embodiment. In the associated drawings,

FIG. 1 shows a top view of an actuator according to the invention,

FIG. 2 shows a perspective representation of the actuator of FIG. 1, and

FIG. 3 shows a further perspective representation of the actuator of FIG. 1.

### DETAILED DESCRIPTION OF THE PREFERED EMBODIMENTS

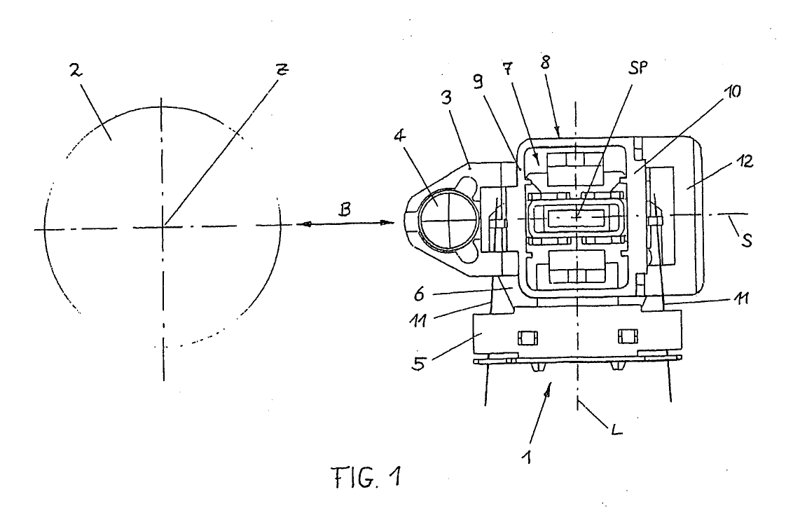

The actuator 1, shown in FIG. 1, as component of a scanning device, not shown in greater detail, for scanning an optical disc 2, has a focus lens 4 held in a lens holder 3 and a damper base 5. The damper base 5 is provided with a support plate 6 for arranging the actuator 1 on the optical housing of the scanning device which carries on the side facing away from the optical housing magnets 7 of a coil and magnet arrangement in a known manner, which also comprises focus, track guidance and tilt coils in order to perform fine positioning of the focus lens 4. This coil and magnet arrangement is enclosed by a frame 8 arranged symmetrically with respect to the arrangement, which frame is connected at the outside of each of its two side walls 9 and 10, extending in parallel with the centrally arranged longitudinal axis L of the actuator 1, with two elastically flexible suspension wires 11 each, to the damper base 5.

On the outside of the disc-facing side wall 9 of the frame 8, the lens holder 3 is moulded on in one piece, and on the outside of its side wall 10 facing away from the disc 2, a balance weight 12 is moulded on in one piece; they are each constructed symmetrically with respect to an axis of symmetry S extending transversely to the longitudinal axis L. The axis of symmetry S intersects the longitudinal axis L of the actuator 1 in its center point of mass or center of gravity SP. The lens holder 3 with the focus lens 4 is arranged on the side facing the receptacle device for the disc 2 and thus on the disc side at the actuator 1 and is being moved, for positioning over or at a vertical distance from the information track, along the axis of symmetry S and thus transversely to the longitudinal axis L in the radial direction towards the disc 2 and correspondingly also away from it (direction arrow B).

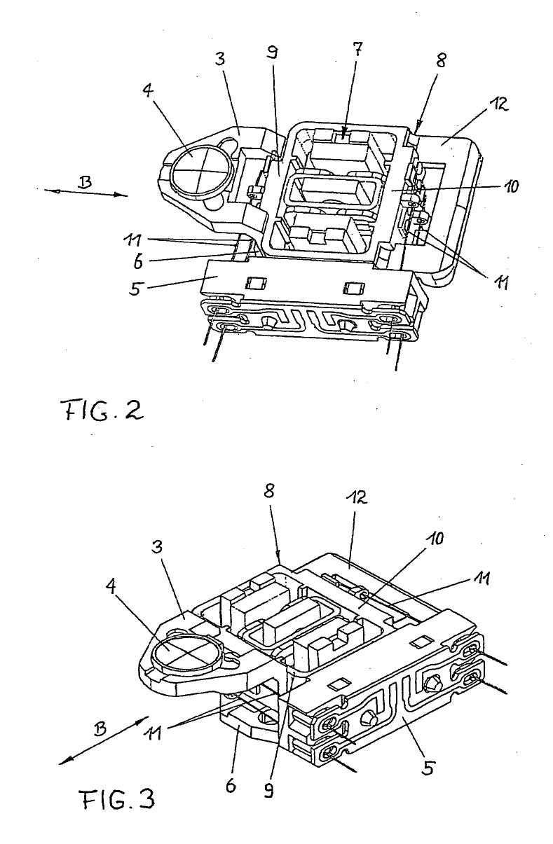

In FIGS. 2 and 3, the actuator 1 is shown in two perspective representations. These are intended to illustrate its configuration and the arrangement of the focus lens 4 and of the balance weight 12. FIG. 2, in particular, shows that the balance weight 12 protrudes between the two suspension wires 11 engaging the frame 8 on the side of the balance weight. The lens holder 3, on the other hand, protrudes perpendicularly to the support plate 6 over the disc facing side wall 9 and, above the disc facing side wall 9 and the suspension wires 11, is angled away towards the outside in parallel with the support plate 6. The focus lens 4 thus protrudes from the actuator 1, both in the direction towards the center of the disc 2 to be scanned as well as towards the top with respect to the coil and magnet arrangement, and cannot be impeded by the remaining components of the actuator 1 during the positioning above the information track near the center Z of the disc 2.

An illustrative embodiment alternative to the arrangement of the actuator 1 with the frame 8 and the side walls 9, 10 shown in FIGS. 1 to 3, consists in that a center part of the actuator 1 exclusively consists of a printed circuit board arranged in parallel with the coils of the coil and magnet arrangement, and the lens holder 3 and the balance weight 12 are attached to opposite ends of this circuit board. Such an arrangement advantageously has a reduced weight and thus a reduced moment of inertia.

What is claimed is:

1. An actuator for a scanning device for scanning optical discs, with a focus lens fixed in a lens holder, with a damper base permanently connected to a support, and with magnets, arranged on the support, of a coil and magnet arrangement for fine positioning of the focus lens, with the lens holder being connected to the damper base via elastically flexible suspension means arranged on both sides of the coil and magnet arrangement and of the longitudinal axis of the actuator, wherein the lens holder is arranged at a distance from the longitudinal axis and at the same time on the side of the actuator facing a receptacle for the optical discs.

2. The actuator of claim 1, wherein the lens holder is arranged at a lateral distance from the center of gravity, located in the area of the longitudinal axis, of the actuator.

3. The actuator of claim 1, wherein a balance weight for positioning the center of gravity into the area of the longitudinal axis is arranged on the side of the longitudinal axis facing away from the lens holder.

4. The actuator of claim 3, wherein the lens holder and the balance weight are arranged on a frame enclosing the coil and magnet arrangement.

5. The actuator of claim 4, wherein the lens holder, the balance weight and the frame are together constructed in one piece.

6. The actuator of claim 4, wherein the frame is connected to the suspension means for the lens holder.

7. The actuator of claim 1, wherein the actuator forms, together with an optical housing, a scanning device which is moved transversely to its longitudinal axis.

8. Device for reading and/or writing optical storage media, having an actuator according to claim 1 and a scanning device formed by means of the latter.
